(19) United States
(12) Patent Application Publication
(10) Pub. No.: US 2026/0142104 A1
(43) Pub. Date: May 21, 2026

(54) VACUUM INTERRUPTER FOR SWITCHING VOLTAGES

(71) Applicant: Siemens Energy Global GmbH & Co. KG, München (DE)

(72) Inventors: Paul Gregor Nikolic, Erlangen (DE); Katrin Benkert, Schwaig (DE); Martin Koletzko, Baiersdorf OT Igelsdorf (DE)

(21) Appl. No.: 18/291,323

(22) PCT Filed: Jun. 28, 2022
(86) PCT No.: PCT/EP2022/067722

§ 371 Date: Jan. 23, 2024

(30) Foreign Application Priority Data
Jul. 23, 2021 (DE) 10 2021 207 963.6

(51) Int. Cl. H01H 33/662

(52) U.S. Cl. CPC H01H 33/662

(57) ABSTRACT

A vacuum interrupter for switching voltages is particularly configured for high voltages in a range greater than or equal to 52 kV. The vacuum interrupter has at least one covering envelope, at least one fixed contact, and at least one movable contact. At least one control element is arranged on the vacuum interrupter.

The invention relates to a vacuum interrupter for switching voltages, having at least one covering envelope and having at least one fixed contact and having at least one movable contact.

Vacuum interrupters or vacuum switches which comprise arrangements of vacuum interrupters are power switches in which switching contacts which can be moved relative to each other are arranged in at least one vacuum switching chamber. In high-voltage technology, such vacuum interrupters are used to switch voltages in the high-voltage range, in particular greater than or equal to 52 kV, and/or for switching large currents in the range of up to some tens of kiloamperes. Vacuum interrupters, in particular surrounded by arrangements for switching, are low-maintenance, durable and are driven in a simple and reliable manner particularly by means of spring-loaded drives. For high-voltage requirements, for example, arrangements having a plurality of vacuum interrupters are used, the switching paths of which are electrically connected in series as known, for example, from DE 10 2013 208 419A1 . Alternatively, for example, vacuum interrupters having a plurality of switching paths are used in particular in a vacuum interrupter.

In the case of a plurality of vacuum interrupters and/or vacuum interrupters having a plurality of switching paths, with the switching paths of the vacuum interrupters being open, a voltage division which is adapted to the vacuum interrupters over the vacuum interrupter(s) is desired, that is to say, controlled shutdown, in order to prevent an overload of individual vacuum interrupters or regions of a vacuum interrupter. For example, with a plurality of identically constructed vacuum interrupters or switching paths which are connected one behind the other, the most uniform possible voltage division over the vacuum interrupter or vacuum interrupters or switching paths is desired.

In order to achieve a desired voltage division over the vacuum interrupters or switching paths, for example, passive electrical structural elements, such as, for example, a control resistor and/or a control capacitor are connected in parallel as control elements in order to form a vacuum interrupter. However, these structural elements increase the structural space required for a vacuum switch having a vacuum interrupter for an arrangement having a plurality of vacuum interrupters. In particular with a vacuum interrupter having cleaned and dehumidified compressed air, that is to say, clean air as the insulation gas surrounding the vacuum interrupter, relatively large insulation spacings are required between a vacuum interrupter and a passive electrical structural element and between a passive electrical structural element and an in particular metal switch housing of the arrangement of one or more vacuum interrupters since the compressed air has a relatively low electrical dielectric strength in comparison with other insulating gases, such as, for example, sulfur hexafluoride. In order to achieve adequate insulation between the vacuum interrupters and switches with passive structural elements, for example, the arrangement of the vacuum interrupters and interconnected passive structural elements in different housings is possible. These arrangements are, however, linked with a high spatial requirement and costs.

The passive electrical structural elements, such as, for example, control resistors and/or control capacitors, which are commercially available, have dimensions which are highly suitable for being arranged in an individual housing which is spaced apart from an outer housing of the vacuum interrupters. The materials of the passive electrical structural elements are accordingly optimized without the requirement for a compact, space-saving arrangement or small size of the structural elements. As described above, an extra housing of the passive electrical structural elements, such as, for example, control resistors and/or control capacitors, separate from the outer housing in which the vacuum interrupters are arranged, is linked with high material expenditure, costs and structural space.

An object of the invention is to provide a vacuum interrupter for switching voltages which can be shut down in a controlled manner and which has a small spatial requirement and low costs. In particular, an objective is to provide a vacuum interrupter for high voltages with in particular control elements which have a small spatial requirement with low costs.

The object is achieved according to the invention with a vacuum interrupter for switching voltages having the features of claim 1. Advantageous embodiments of the vacuum interrupter according to the invention for switching voltages are set out in the dependent claims. In this instance, aspects of subject-matter of the main claim can be combined with features of dependent claims and features of the dependent claims can be combined with each other.

A vacuum interrupter according to the invention for switching voltages comprises at least one envelope and at least one fixed contact and at least one movable contact. According to the invention, at least one control element which is arranged on the at least one vacuum interrupter is included. In particular, the at least one control element can be arranged with the vacuum interrupter in a common housing and it is not necessary for the at least one control element to be arranged in a separate housing from the housing of the vacuum interrupter. Consequently, a saving of structural space and costs is involved.

The at least one control element enables a defined, predetermined voltage distribution over the vacuum interrupter with an open electrical contact, that is to say, with spaced-apart contacts of the vacuum interrupter. In particular, a uniform voltage distribution over the vacuum interrupter is possible, whereby occurrences of damage as a result of excess voltages can be prevented and a durably stable reliable function of the vacuum interrupter can be ensured. The arrangement of the at least one control element on the at least one vacuum interrupter enables a compact, space-saving, cost-effective arrangement of the at least one control element and the at least one vacuum interrupter, in particular in a common housing which is filled, for example, with clean air, with a reduced risk of electrical flashovers. A compact construction enables a material saving, in particular a small housing size, reduces costs, and enables the use of alternative switching gases, such as clean air in compact arrangements, and enables a simple, environmentally friendly use of vacuum interrupters.

The at least one control element may be a capacitor and/or a resistor. Capacitors and/or resistors are highly suitable for producing a voltage distribution over at least one vacuum interrupter, in particular in a uniform manner, or to enable a good controlled shutdown over the at least one vacuum interrupter.

The at least one control element may comprise a base member, in particular a ceramic base member. Ceramic material is compact, cost-effective, can be produced in different forms and can be doped for resistors with different predetermined ohmic resistances and/or for capacitors with different, predetermined capacitances.

The base member may comprise aluminum oxide Al₂O₃, barium titanate BaTiO₃, titanium oxide TiO₂ and/or strontium titanate SrTiO₃, and/or contain aluminum oxide Al₂O₃, barium titanate BaTiO₃, titanium oxide TiO₂ and/or strontium titanate SrTiO₃. These materials have the above-described positive properties.

The base member may comprise a material which has a relative permittivity εᵣ in the range from 20 to 2000, in particular in the range from 85 to 170 and/or in the range from 180 to 350 and/or in the range of 1000. In particular, capacitors which are highly suitable for shutting down vacuum interrupters can be produced with the above −27 mentioned relative permittivities.

The base member may be made of a ceramic/polymer composite material and/or contain a ceramic/polymer composite material, in particular in a cast resin matrix. Ceramic/polymer composite materials, in particular in a cast resin matrix, are highly suitable for producing compact, cost-effective capacitors and/or resistors in different forms.

The base member may be made of a glass ceramic material and/or contain a glass ceramic material. Glass ceramic materials are highly suitable for producing compact, cost-effective capacitors and/or resistors in different forms. In particular, ceramic materials are simple to dope and can be produced with desired electrical properties for capacitors and/or resistors.

The at least one control element may comprise a plurality of base members and/or include a plurality of base members, in particular in a state arranged one behind the other in series. As a result of the composition from a plurality of base members, capacitors and/or resistors with any predetermined values in terms of capacitance or ohmic resistance can be produced in a simple, cost-effective manner, in large batch quantities and, for example, combined in a simple manner to form different shapes.

The vacuum interrupter may comprise an envelope covering, in particular having at least one main shield and having at least two ceramic segments, wherein the at least one main shield may be arranged between the at least two ceramic segments. The at least one control element may be arranged on the envelope of the vacuum interrupter, in particular on at least one ceramic segment of the envelope. The arrangement of the at least one control element on the envelope of the vacuum interrupter, in particular on at least one ceramic segment of the envelope, enables a space-saving or room-saving construction with the above-described advantages and an increased electrical resistance to flashovers as a result of the electrically insulating properties of ceramic segments.

The ceramic segments may comprise an in particular insulating glass ceramic material and/or include an in particular insulating glass ceramic material. Glass ceramic material can be produced in a simple and cost-effective manner, with a wide variety of electrical properties, for example, as a good electrical insulator, in a desired compact form, in a temperature-resistant state in particular at furnace temperatures for soldering components of a vacuum interrupter.

The control elements may be coated with a material, in particular an insulating material and/or a semi-conductive material, in particular with control elements in the form of a varistor. In the case of an insulation of the control elements from conductive regions of the envelope of the vacuum interrupter, control elements coated with an insulating material can be used, in order to produce varistor functions control elements coated with semi-conductor materials can be used in a cost-effective and simple manner.

A plurality of shield rings may be included, in particular in each case constructed in an annular and/or circular manner, which in particular may be arranged directly on the envelope of the vacuum interrupter and/or which may surround the circumference of the vacuum interrupter, and/or which may be arranged in a state spaced apart from each other in the longitudinal direction of the vacuum interrupter. Such shield rings enable good shielding of electrical fields of the vacuum interrupter externally and a homogenization of the field distribution of electrical and/or magnetic fields around the vacuum interrupter. The shield rings may be electrically and/or mechanically connected to shields or condensation shields in the vacuum interrupter.

The at least one control element may be electrically and/or spatially arranged between the at least one fixed contact and the at least one movable contact, in particular between the at least one fixed contact and a shield ring, and/or between at least one fixed contact and a main shield, and/or between a shield ring and a main shield, and/or between two shield rings, and/or between the at least one movable contact and a shield ring, and/or between at least one movable contact and a main shield. An electrical contacting of the control elements may be carried out via the contacts, shield rings and/or the main shield. The arrangement of the control elements on the circumference of the vacuum interrupter, between the contacts, shield rings and/or main shield, enables a space-saving, compact arrangement, simple electrical contacting, uniform field distribution with uniform arrangement around the circumference of the vacuum interrupter, and in particular uniform discrete division of the capacitances and/or ohmic resistances between the contacts, shield rings and/or main shield. This enables a discrete division of the capacitances and/or ohmic resistances along the longitudinal axis and/or along the circumference of the vacuum interrupter, and a selective or defined controlled shutdown or voltage distribution along the longitudinal axis and/or along the circumference of the vacuum interrupter.

The at least one control element may be metal-coated and/or include metal caps, in particular at end faces of the at least one control element, configured for an electrical and/or mechanical contacting, in particular with shield rings, in particular in a soldering process. Consequently, a simple and cost-effective electrical contacting and connection of control elements on the at least one vacuum interrupter is possible, in particular in a time-saving and cost-saving manner in a production process, for example, a soldering process, of the at least one vacuum interrupter.

The at least one control element may have a cylindrical shape, in particular having a circular or elliptical base face. Alternatively, the at least one control element may have a shell-like shape, in particular with concave and/or convex circumference shapes, in particular inversely mirroring the shape of the envelope of the vacuum interrupter. Consequently, simple and cost-effective control elements, which can be arranged in a compact and space-saving manner on the at least one vacuum interrupter can be used with the above-described advantages.

The at least one control element and/or the control elements may have an overall capacitance in the range from to 4000 pF, in particular in the range from 500 to 4000 pF.

These values enable a selective or defined controlled shutdown or voltage distribution along the longitudinal axis and/or along the circumference of the vacuum interrupter, with an overall value in particular for a controlled shutdown at high voltages in the range greater than or equal to 52 kV. The vacuum interrupter may be constructed to switch voltages in the high-voltage range, in particular in the range greater than or equal to 52 kV. Exemplary embodiments of the invention will be illustrated schematically in the Figures below and described in greater detail below.

In the Drawings:

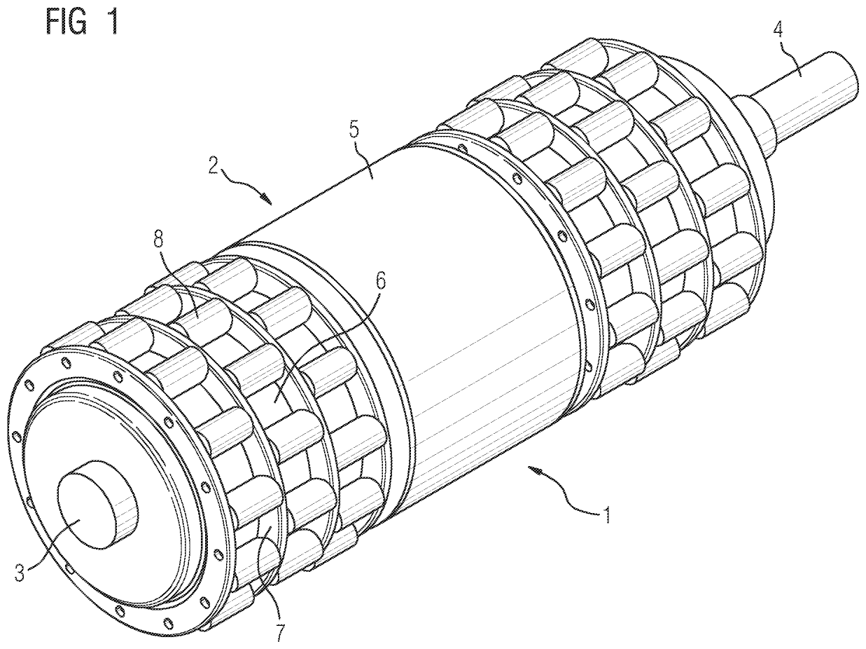

FIG. 1 schematically shows a vacuum interrupter 1 according to the invention for switching voltages, when viewed obliquely from the side, with control elements 8 arranged directly on an envelope covering 2 of the vacuum interrupter, and

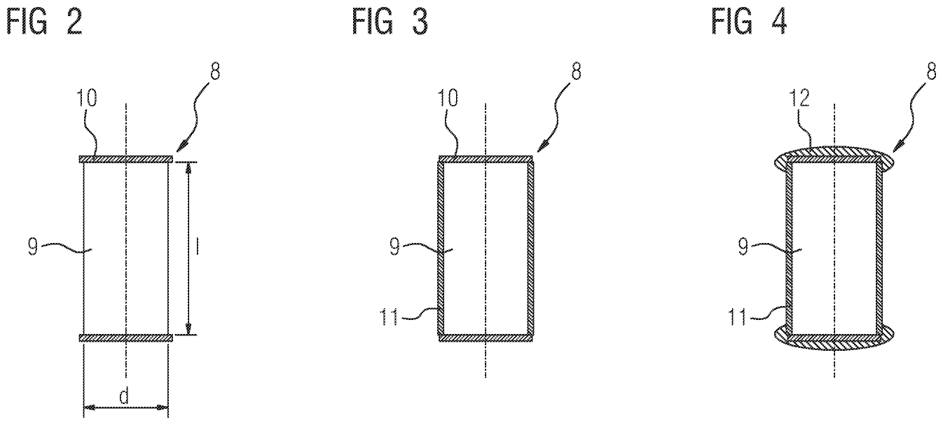

FIG. 2 shows an exemplary embodiment of a control element 8 of the vacuum interrupter 1 according to the invention of FIG. 1, having a base member 9 which has at the ends in each case a metal layer 10 for electrically contacting the control element 8, and

FIG. 3 shows a control element 8 of FIG. 2, which is coated with an insulating and/or semi-conductive coating 11 on the circumference of the base member 9, and

FIG. 4 shows another exemplary embodiment of a control element 8 of the vacuum interrupter 1 according to the invention of FIG. 1, having a base member 9 which has at the ends in each case a shielding cap 12 for electrically contacting the control element 8.

FIG. 1 schematically shows a vacuum interrupter 1 according to the invention for switching voltages, in particular high voltages in the range greater than/equal to 52 kV, when viewed obliquely from one side by way of example, The vacuum interrupter 1 has an envelope 2 which comprises inter alia a central main shield 5 and in each case a ceramic segment 6 which adjoins in a flush manner at the right and left. The main shield 5 and the ceramic segments 6 are constructed in a hollow-cylindrical or tubular manner and closed at the ends of the vacuum interrupter 1 in each case in a fluid-tight manner. Inside, the vacuum interrupter 1 is evacuated or there is applied a vacuum. From the ends of the vacuum interrupter 1, contacts 3 and 4 protrude into the envelope 2 of the vacuum interrupter 1, for example, a fixed contact 3 from one side or base face of the cylinder and a movable contact 4 from the other side or covering face of the cylinder, that is to say, the vacuum interrupter 1.

The main shield 5 is, for example, made of a metal, in particular copper and/or high-grade steel, and comprises, for example, in the interior condensation shields which for the sake of simplicity are not illustrated in the Figures. The hollow-cylindrical ceramic segments are, for example, produced from sintered ceramic material and in particular surface-treated. The contacts 3 and 4 are, for example, made of copper, in particular in a bolt-like manner, with in particular slotted, plate-like ends inside the vacuum interrupter 1. The fixed contact 3 is connected in a fluid-tight manner to a cover-like closure at one end of the vacuum interrupter 1, wherein the closure is produced, for example, from a metal, in particular copper or steel. The movable contact 4 is connected in a fluid-tight manner to a cover-like closure at the other end of the vacuum interrupter 1, for example, movably supported by means of a bellows, which for the sake of simplicity is not illustrated in the Figures, wherein the closure is produced, for example, from a metal, in particular copper steel.

Via the outwardly guided pins of the fixed contact 3 and the movable contact 4, the vacuum interrupter can be electrically contacted. The movable contact 4 enables electrical switching by moving toward the fixed contact 3, that is to say, in order to close a gap between the plate-like 9 contact ends of the contacts 3 and 4, when switching on, and by moving away from the fixed contact 3, that is to say, in order to produce a gap between the plate-like contact ends of the contacts 3 and 4, when switching off. The gap produced between the contact ends of the contacts 3 and 4 and the contact ends themselves are arranged in the evacuated interior of the vacuum interrupter 1, whereby a gap in the range from millimeters to centimeters for switching off in particular high voltages is sufficient. The vacuum interrupter 1 has, for example, a length in the range in particular from 30 to 100 centimeters and a circumference in the range in particular from 10 to 100 centimeters.

According to the invention, around the circumference of the vacuum interrupter 1 control elements 8 are arranged on a envelope 2 of the vacuum interrupter 1. Control elements 8 are, for example, capacitors and/or resistors. Capacitors are in particular ceramic capacitors, for example, with values of the capacitance of individual capacitors in the range from 10 to 4000 pF. Consequently, there is an overall capacitance of the arrangement in the range, for example, from 10 to 4000 pF. Resistors are in particular ohmic resistors, for example, with values of individual resistors in the range of a few Ohm, or a few hundred Ohm, or a few thousand Ohm, or up to a few hundred thousand Ohm. Consequently, there is an overall resistance in the range of a few Ohm, or a few hundred Ohm, or a few thousand Ohm, or up to a few hundred thousand Ohm.

The control elements 8 have, for example, a cylindrical, rectangular, elliptical and/or shell-like form. An arrangement of the control elements 8 around the circumference of the envelope 2 of the vacuum interrupter 1 is carried out, for example, in a circular manner along the cross section of the circumference, wherein the control elements are connected in particular parallel with each other, in particular with regular and/or identical spacings from each other, and/or is carried out along the longitudinal axis of the vacuum interrupter 1, in a state electrically connected in series. An electrical contacting of adjacent control elements 8 which are connected in series one behind the other is carried out, for example, by means of shield rings 7, which are arranged in a circular or annular manner along the cross section of the circumference of the vacuum interrupter 1, with shield rings 7 spaced apart from each other along the longitudinal axis of the vacuum interrupter 1.

As illustrated in FIG. 1, the control elements 8 are, for example, electrically and spatially arranged along the circumference of the envelope 2 of the vacuum interrupter 1 with spacing on a circular cross section of the circumference of the vacuum interrupter 1, along the longitudinal axis of the vacuum interrupter 1 between the fixed contact 3 and the movable contact 4, in particular between the fixed contact 3 and a shield ring 7, between adjacent shield rings 7, between a shield ring 7 and the main shield 5, between the main shield 5 and a shield ring 7, between adjacent shield rings 7, between a shield ring 7 and the movable contact 4, in particular symmetrically arranged. In this instance, the shield rings 7 and the main shield 5 provide the highly electrically conductive contacting of the control elements 8 with each other and between or with the contacts 3 and 4, for example, via the cover-like closures at the ends of the vacuum interrupters 1, and in particular with the movable contact 4 via the bellows.

Shield rings 7 are, for example, made of a metal, in particular copper, and can subdivide ceramic segments 6 via in particular condensation shields which protrude into the vacuum interrupter 1. A connection of the elements of the vacuum interrupter 1, such as, for example, ceramic segments 6, main shield 5, shield rings 7, cover-like closures, and/or with control elements 8, is carried out, for example, by means of soldering and/or conductive bonding. An arrangement of the control elements 8 on the vacuum interrupter 1 or the covering envelope 2 of the vacuum interrupter 1, comprises a materially engaging mechanical contact with the envelope 2 and/or a small spacing in the range of millimeters, wherein the direct contact with the envelope is carried out, for example, by means of the shield rings 7, the main shield 5 and/or the cover-like closures.

Control elements 8 between different shield rings 7 are, for example, arranged along the longitudinal axis of the vacuum interrupter 1 on parallels of the longitudinal axis on in particular straight or curved lines, or in each case so as to be offset with respect to each other. The arrangement of the control elements 8 on the circumference of the vacuum interrupter produces, for example, regular or irregular patterns. An arrangement of the control elements 8 on the circumference of the vacuum interrupter 1 or the covering 2 thereof is space-saving, with a minimized cross section.

FIG. 2 shows an exemplary embodiment of a control element 8 of the vacuum interrupter 1 according to the invention of FIG. 1 in detail. The control element 8 comprises a base member 9 which comprises, for example, a ceramic material and/or contains a ceramic material. The base member 9 is, for example, made of aluminum oxide Al₂₃, barium titanate BaTiO₃, titanium oxide TiO₂, and/or strontium titanate SrTiO₃ and/or contains aluminum oxide Al₂₃, barium titanate BaTiO₃, titanium oxide TiO₂, and/or strontium titanate SrTiO₃. The material of the base member 9 has, for example, a relative permittivity εᵣ in the range from 20 to 2000, in particular in the range from 85 to 170 and/or in the range from 180 to 350 and/or in the range of 1000. Alternatively or additionally, the base member 9 comprises a ceramic/polymer composite material and/or comprises a ceramic/polymer composite material, in particular in a cast resin matrix, or is made of a glass ceramic material and/or contains a glass ceramic material.

The base member 9 is, for example, constructed in a cylindrical manner, with a circular-cylindrical or elliptical base and covering face. Or the base member 9 is constructed in a shell-like manner, for example, with a concave and/or convex covering face in order, for example, to inversely mirror the form of the envelope 2 of the vacuum interrupter 1. A particularly compact, space-saving arrangement of the control elements 8 with the base member 9 on the envelope 2 of the vacuum interrupter 1 is thereby possible. On the base and covering faces or ends of the base member 9, for example, metal layers 10 are provided for electrical contacting and connection of the control elements 8.

The metal layers 10 are applied to the base member 9, for example, by means of coating methods such as evaporation deposition, sputtering, pressing on, and/or electrochemical coating. The metal layers 10 comprise or contain, for example, electrically highly conductive metals, such as, for example, copper, steel, tin solder and/or silver. During production of the vacuum interrupter 2 in a furnace at high temperatures, in particular below 1000 degrees Celsius, at which, for example, components such as ceramic segments 6 and shield rings 7 are connected to each other, a securing of the control elements 8 on the vacuum interrupter 1 or envelope 2 of the vacuum interrupter 1 is thus possible in a simple and cost-effective manner, for example, on shield rings 7, a main shield 5 and/or metal caps or a bellows of the vacuum interrupter 1 at the ends of the movable and fixed contacts 3, 4. The securing may, for example, be carried out in the furnace by means of a soldering process, whereby the control elements 8 are electrically connected to each other, for example, by means of shield rings 7, the main shield 5 and/or metal caps or a bellows of the vacuum interrupter 1 at the ends of the movable and fixed contacts 3, 4.

FIG. 3 shows another exemplary embodiment of the control element 8 of FIG. 2, which is coated with an insulating and/or semi-conductive coating 11 on the circumference of the base member 9. An insulating coating 11 enables electrically insulating bridging of regions of the vacuum interrupter 1 by the control element 8, which must or should not be in electrical contact with the base member 9, for example, shield rings 7, which should or must not contact the respective control element 9, in order to produce a specific circuit diagram or a predetermined circuit. Control elements 9 can thereby be arranged directly, in particular in a non-positive-locking manner on the envelope 2 of the vacuum interrupter 1 without producing undesirable connections and/or short-circuits. A compact, space-saving and cost-saving arrangement of the control elements 9 on the vacuum interrupter 1 thereby becomes possible, with the above-described advantages. Insulating coatings 11 can, for example, be produced by means of insulating paints and/or by means of electrically insulating polymer coatings.

A semi-conductive layer 11 or coating as a covering of the base member 9 of the control elements 8 enables the formation of control elements 8, for example, with a varistor function, in order to produce predetermined connections in order to shut down the vacuum interrupter 1 or vacuum interrupters 1 in a controlled manner. Semi-conductive coatings 11 can be generated or produced, for example, by means of doping, vapor deposition, sputtering and/or electrochemical deposition.

FIG. 4 shows another exemplary embodiment of a control element 8 of the vacuum interrupter 1 according to the invention of FIG. 1, having a base member 9, which has at the ends in each case a shielding cap 12 for electrical contacting of the control element 8. The shielding caps 12 are, for example, provided alternatively or additionally to the metal layers 10 on the base and covering faces or ends of a respective base member 9, in particular for electrically highly conductive contacting and connection of the control elements 8. The shielding caps 12 are, for example, pressed on, for a simple and cost-effective production of control elements 8.

The above-described exemplary embodiments may be combined with each other and/or can be combined with the prior art. Thus, for example, more than two vacuum interrupters 1 can be connected to each other, in particular in series. The control elements 8 may have different shapes, in particular circular-cylindrical, cylindrical with elliptical base and covering face, rectangular, square shapes and/or shapes with a convex and/or concave surface. A securing of the control elements 8 is carried out, for example, on the vacuum interrupter 1 by means of soldering, in particular on metal components, such as, for example, copper components, by means of screwing, by means of adhesive bonding, by means of clamping and/or by means of welding. The control elements 8 are, for example, arranged directly in a non-positive-locking manner on the envelope 2, in particular on ceramic segments 6, in particular on ceramic segments 6, in particular in a state electrically insulated from the ceramic segment by means of an insulating paint and/or a surface-coating and/or treatment and/or control elements 8 are arranged, for example, directly on the envelope 2, in particular on ceramic segments 6, with a small spacing from the ceramic segments 6, in particular between the shield rings 7, main shield 5 and/or contacts 3, 4, for example, screwed, clamped, soldered, adhesively bonded and/or welded. A small spacing is, for example, in the range from a few millimeters up to a centimeter.

The control elements 8 are, for example, arranged on the envelope 2 of the vacuum interrupter 1 or vacuum interrupters 1 as discrete components, in particular with spacing from each other. In this instance, an arrangement is carried out, for example, in an annular manner, along a, for example, circular cross section of the vacuum interrupter 1, with different rings along the longitudinal axis of the vacuum interrupter 1. Adjacent control elements 8 in different rings are, for example, arranged on straight lines or offset with respect to each other. Alternatively, an arrangement of the control elements 8 can be carried out, for example, on a helical line or helix. Further arrangements and/or combinations of arrangements are also possible.

A control element 8 comprises and/or contains, for example, a base member 9, in particular with metal coating 10, 12 for electrically contacting at the ends. Control elements may also comprise a plurality of base members 9 and/or include a plurality of base members 9, in particular arranged one behind the other in series, in order to produce any desired predetermined values, such as, for example, capacitances and/or ohmic resistances and/or to achieve predetermined lengths for circuits which are intended to be produced. Lengths of control elements 8 are, for example, in the range from 10 to 100 millimeters and widths of control elements 8 are, for example, in the range from 10 to 80 millimeters, in particular for controlled shutdowns of voltages in the range of 100 kV. Controlled shutdowns can be carried out with corresponding connection of control elements 8, for example, also in the range of 145 kV, 245 kV and/or 420 kV.

With the above-described vacuum interrupter 1 according to the invention, via the control elements 8 a controlled shutdown of voltages via the vacuum interrupter 1 is possible. Vacuum interrupters 1 can be connected in series one behind the other, in particular in order to switch high voltages in the range greater than or equal to 52 kV. Voltages can be divided in a manner predetermined in a uniform or different manner, by means of the selection of the control elements 8 and the connection thereof on the vacuum interrupter 1 or vacuum interrupters 1 and/or over elements of the vacuum interrupters 1, such as, for example, ceramic segments 6 with different lengths. The direct arrangement of the control elements 8 on the vacuum interrupter 1 or the vacuum interrupters 1 enables a compact, space-saving construction, which enables a cost-effective, spatially minimized housing and in particular allows the use of insulating gases, such as, for example, clean air with small or minimized and/or standard dimensions of housings.

### LIST OF REFERENCE NUMERALS

1 Vacuum interrupter
2 Envelope
3 Fixed contact
4 Movable contact
5 Main shield
6 Ceramic segment
7 Shield ring
8 Control element
9 Base member
10 Metal layer
11 Coating
12 Shield cap
d Diameter
l Length

1-17. (canceled)

18. A vacuum interrupter for switching voltages, the vacuum interrupter comprising:
at least one envelope, at least one fixed contact, and at least one movable contact; and
at least one control element arranged on the vacuum interrupter.

19. The vacuum interrupter according to claim 18, wherein said at least one control element is at least one of a capacitor or a resistor.

20. The vacuum interrupter according to claim 18, wherein said at least one control element comprises a base member.

21. The vacuum interrupter according to claim 20, wherein said base member is formed of at least one material selected from the group consisting of aluminum oxide Al₂O₃, barium titanate BaTiO₃, titanium oxide TiO₂, and strontium titanate SrTiO₃, or said base member contains at least one material selected from the group consisting of aluminum oxide Al₂O₃, barium titanate BaTiO₃, titanium oxide TiO₂, and strontium titanate SrTiO₃.

22. The vacuum interrupter according to claim 20, wherein said base member comprises a material having a relative permittivity εᵣ in a range from 20 to 2000.

23. The vacuum interrupter according to claim 20, wherein the relative permittivity εᵣ lies in a range from 85 to 170.

24. The vacuum interrupter according to claim 20, wherein the relative permittivity εᵣ lies in a range from 180 to 350.

25. The vacuum interrupter according to claim 20, wherein said base member is made of a ceramic/polymer composite material or contains a ceramic/polymer composite material.

26. The vacuum interrupter according to claim 20, wherein said base member is made of a glass ceramic material or contains a glass ceramic material.

27. The vacuum interrupter according to claim 20, wherein said at least one control element comprises a plurality of base members or includes a plurality of base members, arranged one behind another in series.

28. The vacuum interrupter according to claim 18, wherein said envelope has at least one main shield and at least two ceramic segments, said at least one main shield being arranged between said at least two ceramic segments and said at least one control element being arranged on at least one of said ceramic segments of said envelope.

29. The vacuum interrupter according to claim 28, wherein said ceramic segments are formed of a glass ceramic material or include a glass ceramic material.

30. The vacuum interrupter according to claim 18, wherein said at least one control element is coated with an insulating material and/or a semi-conductive material.

31. The vacuum interrupter according to claim 18, wherein said at least one control element is a varistor.

32. The vacuum interrupter according to claim 18, which further comprises a plurality of annular shield rings arranged directly on said envelope, and/or which surround a circumference of the vacuum interrupter, and/or which are arranged spaced apart from one another in a longitudinal direction of the vacuum interrupter.

33. The vacuum interrupter according to claim 18, wherein at least one of the following is true:
said at least one control element is electrically arranged between said at least one fixed contact and said at least one movable contact;
said at least one control element is spatially arranged between said at least one fixed contact and said at least one movable contact;
said at least one control element is arranged between said at least one fixed contact and a shield ring;
said at least one control element is arranged between said at least one fixed contact and a main shield;
said at least one control element is arranged between a shield ring and a main shield;
said at least one control element is arranged between two shield rings;
said at least one control element is arranged between said at least one movable contact and a shield ring; or said at least one control element is arranged between said at least one movable contact and a main shield.

34. The vacuum interrupter according to claim 18, wherein said at least one control element is metal-coated or includes metal caps at end faces of said at least one control element, configured for an electrical and/or mechanical contacting.

35. The vacuum interrupter according to claim 18, wherein said at least one control element has a cylindrical shape with a circular or elliptical base face or said at least one control element is shell-shaped with a concave and/or convex circumference, and inversely mirrors a shape of said envelope.

36. The vacuum interrupter according to claim 18, wherein said at least one control element or a plurality of said control elements have an overall capacitance in a range from 10 to 4000 pF.

37. The vacuum interrupter according to claim 18 configured for switching voltages in a high-voltage range greater than or equal to 52 kV.
